(19) United States
(12) Patent Application Publication
(10) Pub. No.: US 2026/0214159 A1
(43) Pub. Date: Jul. 23, 2026

(54) METHOD AND APPARATUS FOR IDENTIFYING WIRELESS AUDIO DEVICE BASED ON AUDIO ROUTING INFORMATION, COMPUTER DEVICE, AND STORAGE MEDIUM

(71) Applicant: Shenzhen Xuanji Artificial Intelligence Technology Co., Ltd., Shenzhen City (CN)

(72) Inventor: Zewen Wu, Shenzhen City (CN)

(21) Appl. No.: 19/312,180

(22) Filed: Aug. 27, 2025

(30) Foreign Application Priority Data
Jan. 17, 2025 (CN) 202510077480.X

(51) Int. Cl. H04M 1/72463; H04R 1/10

(52) U.S. Cl. CPC H04M 1/72463; H04R 1/1091; H04R 2420/07

(57) ABSTRACT

Provided are a method and apparatus for identifying a wireless audio device based on audio routing information, a computer device, and a storage medium. The method includes: generating, by a wireless audio device after connecting to a mobile phone, a routing notification containing device type, MAC address, and name information of the wireless audio device, and sending the routing notification to an APP of the mobile phone; listening to and receiving, by the APP, the routing notification, and extracting the device type, MAC address, and name information in the routing notification to obtain routing notification content; sending, by the APP, the routing notification content to a server; matching, by the server, the received routing notification content with pre-stored product information; determining, when the routing notification content is consistent with the pre-stored product information in the database, that authentication is successful, and feeding an authentication result back to the APP.

### TECHNICAL FIELD

The present disclosure relates to technologies for identifying wireless audio devices, and more specifically, to a method and apparatus for identifying a wireless audio device based on audio routing information, a computer device, and a storage medium.

### BACKGROUND

In existing technologies for identifying wireless audio devices, a method that adopts Bluetooth scanning and connection to identify a device has many problems. This method has cumbersome and complex operation process, and is inefficient, causing inconvenience to users. Particularly, at an iPhone Operating System (iOS) end, due to restrictions such as permissions, a Media Access Control (MAC) address and other key information of the device cannot be obtained by means of Bluetooth. Consequently, a specific device cannot be accurately identified or labeled based on the MAC address, resulting in poor compatibility and an inability to meet needs of users across different platforms.

### SUMMARY

An objective of the present disclosure is to provide a method and apparatus for identifying a wireless audio device based on audio routing information, a device, and a medium, so as to overcome shortcomings in the prior art.

To solve the above-mentioned technical problems, the present disclosure adopts the following technical solutions:

A first aspect provides a method for identifying a wireless audio device based on audio routing information, including:

generating, by a wireless audio device after connecting to a mobile phone, a routing notification containing device type, Media Access Control (MAC) address, and name information of the wireless audio device, and sending the routing notification to an application (APP) of the mobile phone;

listening to and receiving, by the APP of the mobile phone, the routing notification, and extracting the device type, MAC address, and name information in the routing notification to obtain routing notification content;

sending, by the APP of the mobile phone, the routing notification content to a server, where the server pre-stores a product information database for a plurality of wireless audio devices;

matching, by the server, the received routing notification content with pre-stored product information in the product information database; and

determining, when the routing notification content is consistent with the pre-stored product information in the product information database, that authentication is successful, and feeding an authentication result back to the APP of the mobile phone.

A second aspect provides an apparatus for identifying a wireless audio device based on audio routing information, including:

a connection and sending unit configured to generate, after a wireless audio device connects to a mobile phone, a routing notification containing device type, MAC address, and name information of the wireless audio device, and send the routing notification to an APP of the mobile phone;

a listening, receiving, and extraction unit configured for the APP of the mobile phone to listen to and receive the routing notification, and extract the device type, MAC address, and name information in the routing notification to obtain routing notification content;

a sending unit configured to send the routing notification content to a server by the APP of the mobile phone, where the server pre-stores a product information database for a plurality of wireless audio devices;

a matching unit configured to match the received routing notification content with pre- stored product information in the product information database by the server; and

an authentication and feedback unit configured to: determine, when the routing notification content is consistent with the pre-stored product information in the product information database, that authentication is successful, and feed an authentication result back to the APP of the mobile phone.

A third aspect provides a computer device, including a memory, a processor, and a computer program stored in the memory and executable on the processor, where the processor executes the computer program to implement the steps of the above method for identifying a wireless audio device based on audio routing information.

A fourth aspect provides a computer-readable storage medium, where the computer- readable storage medium stores a computer program, and the computer program is executed by a processor to implement the steps of the above method for identifying a wireless audio device based on audio routing information.

The above method for identifying a wireless audio device based on audio routing information actively sends the routing notification containing the device type, MAC address, and name information to the APP of the mobile phone through the wireless audio device and combines server-side database matching to accurately identify the wireless audio device. This method overcomes problems of inaccurate and inefficient identification that may occur in a traditional identification technique, ensuring accuracy and timeliness of device identification. In addition, this technology uses a Bluetooth audio device as an identification object and has wide compatibility. Regardless of a mobile phone platform, seamless compatibility and adaptation can be achieved provided that the device supports a Bluetooth function. This solves a problem of poor compatibility at an iOS end in the prior art and provides convenience for more users.

The present disclosure is described in further detail below in combination with the accompanying drawings and specific embodiments.

### BRIEF DESCRIPTION OF THE DRAWINGS

In order to describe the technical solutions in the embodiments of the present disclosure more clearly, the accompanying drawings required to describe the embodiments are briefly described below. Apparently, the accompanying drawings described below are only some embodiments of the present disclosure. Those of ordinary skill in the art may further obtain other accompanying drawings based on these accompanying drawings without creative efforts.

FIG. 1 is a schematic flowchart of a method for identifying a wireless audio device based on audio routing information according to an embodiment of the present disclosure;

FIG. 2 is a schematic block diagram of an apparatus for identifying a wireless audio device based on audio routing information according to an embodiment of the present disclosure; and

FIG. 3 is a schematic structural diagram of a computer device according to an embodiment of the present disclosure.

### DETAILED DESCRIPTION OF THE EMBODIMENTS

The technical solutions in the embodiments of the present disclosure are described clearly and completely below with reference to the accompanying drawings in the embodiments of the present disclosure. Apparently, the described embodiments are merely a part rather than all of the embodiments of the present disclosure. All other embodiments obtained by those skilled in the art based on the embodiments of the present disclosure without creative efforts shall fall within the protection scope of the present disclosure.

It should be understood that when used in this specification and the appended claims, the terms "comprise/include" and "contain" indicate the presence of described features, integers, steps, operations, elements and/or components, but do not exclude the presence or addition of one or more of other features, integers, steps, operations, elements, components, and/or sets thereof. It should also be understood that the terms used in the specification of the present disclosure are for the purpose of describing specific embodiments only and are not intended to limit the present disclosure. As used in the specification of the present disclosure and the appended claims, the singular forms "a", "an", and "the" are intended to include the plural forms unless the context clearly indicates otherwise.

It should also be further understood that the term "and/or" as used in the specification of the present disclosure and the appended claims refers to one or any or all possible combinations of a plurality of associated items that are listed, and includes these combinations.

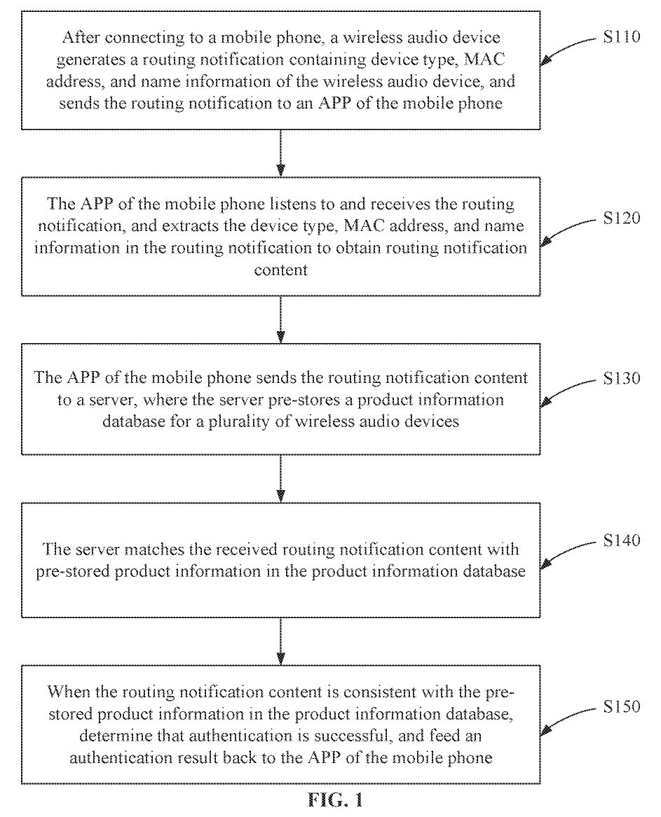

Referring to a specific embodiment shown in FIG. 1, the present disclosure provides a method for identifying a wireless audio device based on audio routing information, including the following steps:

S110: After connecting to a mobile phone, a wireless audio device generates a routing notification containing device type, MAC address, and name information of the wireless audio device, and sends the routing notification to an APP of the mobile phone.

Specifically, a MAC address of the wireless audio device is a unique and unalterable identifier (ID) hardcoded onto the wireless audio device. Due to this characteristic, the MAC address can serve as an ID for an identity of the wireless audio device to distinguish each different device. Accurate and fast device identification and connection status monitoring can be achieved by using the MAC address of the wireless audio device as the ID.

More specifically, the wireless audio device is equipped with a wireless communication module such as a wireless fidelity (Wi-Fi) module or a Bluetooth module to establish a connection to the mobile phone. As a control and information receiving end, the mobile phone runs the APP that can process information from the wireless audio device. An internal program of the wireless audio device collects a device type (such as a stereo earphone), a MAC address, and a device name that is preset by a user or set when the wireless audio device leaves a factory for the wireless audio device. The collected device information is encapsulated into a data packet that follows a specific communication protocol format, including but not limited to a device type field, a MAC address field, and a device name field. When the wireless audio device establishes a stable connection to the mobile phone, the wireless audio device sends the encapsulated data packet to the APP of the mobile phone as the routing notification through an established communication link. In this step, a previously established Wi-Fi or Bluetooth connection channel is used.

In an embodiment, before the step S110, the method further includes:

obtaining, by the APP of the mobile phone, a permission of an audio manager of the mobile phone, and registering a listening function with the audio manager of the mobile phone to listen to a connection status event of the wireless audio device, where when a connection status between the wireless audio device and the mobile phone changes, the APP of the mobile phone receives a status event that has been listened to, and the status event contains device list information.

Specifically, when the user first starts the APP, the APP requests a permission to access the audio manager from an operating system, which is usually implemented through a permission request dialog box of the operating system. The user needs to explicitly grant the permission to access the audio manger to the APP.

Listener registration: Once obtaining the permission, the APP registers a listener with the audio manager through an application programming interface (API) provided by the operating system. The listener is a callback function or an event processor, which is specifically designed to receive a device connection status change event issued by the audio manager. The audio manager continuously listens to connection statuses of all audio devices, including the wireless audio device (for example, a Bluetooth earphone or a wireless speaker). When a connection status of any device changes (for example, the device is connected or disconnected, or a battery level of the device changes), the audio manager triggers the event listener previously registered by the APP.

Information contained in an event: A triggered event contains a status event object that details specific information about a connection status change, including but not limited to: a list of all currently connected audio devices, with each device entry containing information such as a device ID, a device name, and a device type.

Status change detail: It specifically indicates which device has experienced the connection status change (for example, a device A is connected and a device B is disconnected).

Event processing: After receiving the status event, the event listener of the APP parses information in an event object and updates a user interface, sends a notification, or performs other related operations based on a business need.

The APP can dynamically update a device list and a status indicator on the user interface based on the received device list information and status change detail, ensuring that the user can understand a status of a currently connected device in real time. For an important status change, the APP can instantly notify the user through a pop-up window, a voice prompt, or a vibration, enhancing user experience.

More specifically, by directly listening to the status event of the audio manager, the APP can obtain a real-time connection status change of the wireless audio device without a need for scheduled polling, thereby reducing a consumption of a system resource. In addition, a device status is obtained directly from the audio manager, which avoids an information delay or error that may be caused by a third-party library or API, and improves accuracy of information. Furthermore, the user interface can be updated instantly and various forms of user feedback can be provided, such that the user can intuitively understand and manage a connection status of an audio device, thereby improving convenience and satisfaction of a user operation. Additionally, permission requesting and event listening are performed by using a standard API provided by the operating system, such that compatibility and security of the APP are ensured, reducing a security risk caused by using a non-standard method.

S120: The APP of the mobile phone listens to and receives the routing notification, and extracts the device type, MAC address, and name information in the routing notification to obtain routing notification content.

Specifically, once the wireless audio device establishes the connection to the mobile phone, the wireless audio device sends the routing notifications according to a predetermined protocol. After receiving the notification, the listener of the APP immediately parses the notification, which includes identifying a format of the notification, extracting key information (such as the device type, the MAC address, and the name), and verifying integrity of the notification. A field representing the device type is extracted from the routing notification, and the field is typically a code or string used to identify a category of the device. A physical address (MAC address) of the device is extracted, which is a unique ID of the device and used to distinguish between different devices in a network. The name of the device is extracted, which is usually a friendly name specified by the user during device setting for easy identification and management. The APP integrates the extracted device type, MAC address, and name information together to form the complete routing notification content. The content can then be further processed by the APP, for example, displayed to the user, stored in a local database, or sent to a server for verification and recording.

More specifically, by registering the listener and receiving the routing notification in real time, the APP can instantly obtain connection information of the wireless audio device, and the user does not need to manually query or wait for a regular update. In addition, the key information is directly extracted from the routing notification, which avoids loss or tampering of the information during transmission, ensuring the accuracy of the information. The APP can also quickly construct a user-friendly interface element based on the extracted information, such as the device list or the status indicator, allowing the user to intuitively understand and manage the wireless audio device. In addition, the APP can automatically perform a series of management operations based on the routing notification content, such as device authentication, permission allocation, and resource allocation, improving efficiency and automation of device management.

In an embodiment, the step S120 includes:

traversing, by the APP of the mobile phone, the device list information to select the wireless audio device, obtaining the routing notification of the wireless audio device, and extracting the device type, MAC address, and name information in the routing notification to obtain the routing notification content.

Specifically, after the APP is started, a device discovery operation is first performed through the API of the operating system to obtain a list of wireless devices that can be currently connected. The list includes all identifiable wireless devices nearby, including but not limited to the wireless audio device, a smartphone, a computer, and the like. The APP traverses the obtained device list information and checks each device one by one. In this process, the APP preliminarily determines whether a device is the wireless audio device based on some characteristics of the device (such as a device name and a service universally unique identifier (UUID)). The APP determines the wireless audio device by matching a specific feature of the device (for example, the device name contains keywords like "audio" and "speaker", or the service UUID matches a service of a known wireless audio device). In some cases, in order to further improve accuracy of screening, the APP may require the user to select at least one device from determined candidate devices as a true wireless audio device, which can be implemented through list selection on the user interface, quick response (QR) code scanning, and the like. After the connection is established, the APP listens to the routing notification from the wireless audio device, and the notification may include a device status change, the MAC address, the name information, a configuration update, a media control command, and other information. The APP receives the notification by registering the specific callback function or the event listener. When receiving the routing notification, the APP parses the routing notification content to extract the device type, MAC address, and name information in the routing notification, which are usually encoded in specific fields of the routing notification. The APP needs to parse the routing notification based on a format of the notification. After completing the parsing, the APP integrates the extracted information together to form the complete routing notification content. The content can then be further processed by the APP, for example, displayed to the user, stored in the local database, or sent to the server for subsequent processing.

More specifically, by combining feature matching with user confirmation, the APP can accurately determine a target wireless audio device, avoiding an erroneous operation caused by misidentification. In addition, the APP can listen to and receive the routing notification from the wireless audio device in real time, ensuring timeliness and accuracy of the information. Furthermore, the APP provides a user-friendly interface and interaction method, such that the user can easily manage and control the wireless audio device, thereby enhancing the user experience. In addition, the APP can automatically perform a series of management operations based on the routing notification content, such as device status monitoring and configuration updating, improving the efficiency and the automation of the device management.

S130: The APP of the mobile phone sends the routing notification content to the server, where the server pre-stores a product information database for a plurality of wireless audio devices.

Specifically, after extracting the routing notification content (including the device type, the MAC address, the name, and other information), the APP of the mobile phone encapsulates the extracted information into a data structure or a message body to facilitate transmission and parsing. To ensure security of data transmission, the APP encrypts the encapsulated message body, which can be implemented by using a symmetric encryption algorithm (such as an Advanced Encryption Standard (AES)) or an asymmetric encryption algorithm (such as Rivest-Shamir-Adleman (RSA)). In addition, key or certificate exchange may be required to ensure legitimacy of both parties in encrypted communication. The APP sends a request to the server through Hypertext Transfer Protocol (HTTP), Hypertext Transfer Protocol Secure (HTTPS), or another network protocol, and the request contains the encapsulated and possibly encrypted message body. The request may use an HTTP method such as POST or PUT, depending on API design and business logic of the server. A network module on a server side receives the request from the APP and parses the request to extract the message body. If the message body is encrypted, the server uses a corresponding key or certificate to decrypt the message body. In addition, the server further performs security verification on the request to ensure that the request originates from a legitimate APP instance. The server then parses the decrypted message body to extract key information such as the device type and the MAC address, and performs a query in the product information database to match corresponding product information. The product information database may include a detailed specification, a warranty status, a user manual, and other data of the device.

More specifically, synchronization and centralized management of the device information are achieved by sending the routing notification content to the server and matching the routing notification content with the product information database. This helps an enterprise to better track and manage an inventory, a warranty status, and a usage status of its own wireless audio device. In addition, through encrypted communication and security verification mechanisms, security and integrity of a data transmission process are ensured, preventing leakage and tampering of sensitive information.

S140: The server matches the received routing notification content with pre-stored product information in the product information database.

Specifically, the server is equipped with a high-performance processor and a large- capacity memory to efficiently process massive routing notification content matching requests. In addition, the server also runs a stable and reliable operating system and database management system (DBMS), such as MySQL and PostgreSQL, for storing and managing the pre-stored product information database. The database contains a plurality of tables that store product information of different types of wireless audio devices. The product information includes, but is not limited to, a device model, a serial number, a MAC address, a manufacturer, a production date, a warranty period, a technical specification, and the like. Each device has a unique ID (such as the MAC address or the serial number) for precise matching in the product information database. The server is equipped with a dedicated receiving module to receive the routing notification content from the APP of the mobile phone or another mobile phone. The notification content is typically encapsulated in a JavaScript Object Notation (JSON), eXtensible Markup Language (XML), or binary format and contains relevant device information. The receiving module transmits the received notification content to a parsing module. The parsing module parses the notification content based on a predefined format and extracts key device information (such as the device type and the MAC address). The server matches the parsed device information with the pre-stored product information in the product information database by using a high-efficiency matching algorithm. The matching process may involve comparison of a plurality of fields such as a device model field and the MAC address field to ensure matching accuracy. In order to enhance matching efficiency, the server may perform query optimization on the database. For example, an index is established for a frequently used query field, a caching technology is used to reduce access to the database, or a distributed database architecture is adopted to share a query load. The matching algorithm returns a matching result, including: matched product information (such as the device model, the manufacturer, and the warranty period) and a matching status (such as successful matching or failed matching). Based on the matching result, the server constructs a response message containing the matched product information, a matching status code, and the like. The response message is usually encapsulated in a same format as the notification content for easy parsing and processing by the mobile phone. The server is equipped with a sending module to transmit the constructed response message to the mobile phone through a previously established connection or a new network connection.

More specifically, by employing the high-efficiency matching algorithm and a query optimization technology, the server can rapidly and accurately match the routing notification content with the pre-stored product information in the product information database, thereby enhancing the system responsiveness and the user experience. In addition, the server precisely matches the received routing notification content with the pre-stored product information in the product information database. This ensures data consistency and accuracy and helps the enterprise to better manage the inventory and the warranty status of its own wireless audio device. Additionally, the server is equipped with the high-performance processors, the large-capacity memory, and a scalable database architecture, such that the system can process massive matching requests and data storage requirements. The system also supports a plurality of formats of notification content and response messages, enhancing flexibility and compatibility of the system. In addition, the server adopts the encrypted communication and security verification mechanisms, ensuring the security and the integrity of the data transmission process. The server also has high reliability and high fault tolerance and can automatically recover or switch to a backup server during a network fault or a hardware fault, ensuring stable running of the system.

S150: When the routing notification content is consistent with the pre-stored product information in the product information database, determine that authentication is successful, and feed an authentication result back to the APP of the mobile phone.

Specifically, if the server finds product information that exactly matches the routing notification content in the product information database, the device is recognized as legitimate and registered, indicating that the authentication is successful. In this case, the server generates an authentication success flag or status code for subsequent processing and feedback. Once the authentication is successful, the server constructs, based on a preset format, a response message containing the authentication result. The response message typically includes: an authentication status code, the device information (such as the device model and the MAC address, which are used for confirming the authenticated device), and other possible additional information (such as an authentication validity period and a permission level). The server sends the constructed response message to the APP of the mobile phone through the previously established connection or the new network connection. In a sending process, the server may take encryption or other security measures to ensure secure transmission of the response message. After receiving the response message of the server, the APP of the mobile phone obtains the authentication result through parsing, and performs corresponding processing as required. For example, if the authentication is successful, the APP may update the user interface to display information indicating that the device has been authenticated, or unlock some functions depending on device authentication.

If the server does not find the product information that exactly matches the routing notification content in the product information database, the authentication fails. In this case, the server generates an authentication failure flag or status code, incorporates the authentication failure flag or status code into the response message, and transmits the response message to the APP of the mobile phone. After receiving a result indicating failed authentication, the APP prompts the user to check the device information or reattempt the authentication. In matching and authentication processes, the server may encounter various errors such as a database connection failure and a data parsing error. For these errors, the server records corresponding error information, generates a response message containing an error code, and sends the response message to the APP of the mobile phone. After receiving the error response, based on the received error code, the APP processes a corresponding error or prompts the user.

More specifically, by matching the routing notification content with the pre-stored product information in the product information database, the server can verify legitimacy and a registration status of the device. This prevents an unauthorized device from connecting to a network or accessing a sensitive resource, which helps enhance security of the entire system. After the successful authentication, the server feeds the authentication result back to the APP of the mobile phone in a timely manner, enabling the user to immediately understand an authentication status of the device. This helps improve the user experience, and reduces inconvenience and anxiety caused to the user when the user waits for the authentication result. The server records detailed error information and logs during the authentication, allowing a system administrator to discover and solve a potential problem in the timely manner. Concurrently, the server is designed with the high availability and the high fault tolerance, which also ensures the stable running of the system in the case of an exception. Furthermore, the server adopts centralized authentication, and can support concurrent authentication requests from a plurality of devices. This helps meet access and management requirements of a plurality of devices in a large-scale network environment.

In an embodiment, after the step S150, the method further includes:

granting, by the APP of the mobile phone, a subsequent function permission to the wireless audio device, and allowing the wireless audio device to perform an audio playback operation or a setting adjustment operation.

Specifically, the APP of the mobile phone provides a user interface for displaying a list of subsequent function permissions that can be obtained by the wireless audio device. These permissions may include audio playback, volume adjustment, sound quality setting, enabling/disabling of simultaneous translation, conference mode setting, and the like. Through the interface of the APP of the mobile phone, the user selects a desired function permission to be granted to the wireless audio device and confirms an authorization operation. Upon receiving a confirmation instruction of the user, the APP generates corresponding authorization information. The APP of the mobile phone sends the authorization information to the wireless audio device through the previously established connection. The authorization information may include an ID of the function permission, an authorization validity period, a user ID, and the like. After receiving the authorization information, the wireless audio device parses the authorization information to identify the granted function permission. The wireless audio device performs a corresponding operation based on the function permission obtained through the parsing. For example, if an audio playback permission is granted, the device can play an audio stream sent by the APP of the mobile phone. If the simultaneous translation is authorized, the device can receive and translate audio inputs in different languages and output a translation result to the user. During function execution, the wireless audio device may send a status feedback message to the APP of the mobile phone to report a progress, a result, or an error of the operation. The APP of the mobile phone provides a management interface, which allows the user to view at any time a function permission that has been granted to the wireless audio device, and perform a modification or cancellation operation. When the user determines to cancel a function permission, the APP generates a corresponding cancellation instruction and sends the cancellation instruction to the wireless audio device through a connection. After receiving the cancellation instruction, the device stops an operation related to the function permission and updates its internal status.

More specifically, by granting the subsequent function permission to the wireless audio device through the APP of the mobile phone, the user can flexibly control a function of the device to meet personalized usage needs, which helps enhance user satisfaction and loyalty. Additionally, through device identification, verification, and permission management mechanisms, it can be ensured that only a legitimate and registered device can obtain a function permission, thereby preventing the unauthorized device from accessing and using a sensitive function. This helps improve the security of the entire system. In addition, the APP of the mobile phone serves as a control center, and can conveniently update and expand a list of function permissions. Therefore, the wireless audio device can be continuously upgraded and expanded, which helps extend a lifespan and competitiveness of the device. Furthermore, after being granted with different function permissions, the wireless audio device can adapt to demands of various application scenarios, such as the simultaneous translation, meeting recording, and music playback, which helps expand an application scope and a market share of the device.

In an embodiment, the APP of the mobile phone can also construct a user profile by collecting the user's usage habit (such as a frequently connected wireless audio device or a commonly used audio setting).

Specifically, each time the user connects the wireless audio device (such as the Bluetooth earphone or the wireless speaker), the APP records the device information such as the MAC address, the name, connection time, and disconnection time. The APP records frequently used audio settings of the user, including a volume, an equalizer setting, an audio effect mode (such as a pop, rock, or classical mode), and whether to enable surround sound. Then, collected original data undergoes duplicate removal and noise reduction to ensure data accuracy and integrity. After that, statistical analysis is conducted on a connection record and an audio setting record of the wireless audio device to identify the user's usage preference and habit. Based on a data analysis result, a tag is generated for the user, such as "a user preferring to use the Bluetooth earphone", "a user liking a high volume", or "a classical music enthusiast", and other information (such as registration information, usage duration, and a purchase record) of the user is combined to further enrich and perfect the user profile. Finally, based on the user profile, personalized recommendations for an audio device and a sound effect setting are provided to the user. In addition, through a user survey, a user interview, and other means, the user's feedback on a personalized recommendation and setting can be collected, which can be used to optimize the user profile and a recommendation algorithm.

By constructing the user profile, the following benefits can be achieved:

Enhancing the user experience: By collecting and analyzing the user's usage habit, the APP can provide the user with more personalized audio experience, thereby meeting a personalized need of the user.

Optimizing a product function: Based on the user profile, an APP developer can more accurately understand the user's need and preference, thereby optimizing function and interface design of a product, and enhancing competitiveness of the product.

Enhancing marketing effectiveness: Based on the user profile, the APP can more accurately determine a target user and formulate a targeted marketing strategy, thereby improving the marketing effectiveness and a conversion rate.

Increasing user stickiness: Personalized recommendations and services strengthen the user's dependency and stickiness towards the APP, increasing a retention rate and an activity level of the user.

In an embodiment, based on the user profile and a machine learning algorithm, the APP can intelligently recommend a most suitable wireless audio device or a specific function configuration for the user.

Specifically, based on the user profile, the APP continuously collects the user's usage data, including but not limited to an audio type preferred by the user, a frequency of using the wireless audio device, a frequently accessed audio content platform, and a user feedback. Then, based on the collected data, the user profile is constructed by using data mining and clustering analysis techniques, to identify an audio preference, a device usage habit, and other characteristics of the user. As a user behavior changes, the user profile is updated regularly or in real time to ensure accuracy and timeliness of the user profile.

Additionally, a recommendation model is trained based on historical user data and device performance data by means of supervised learning or unsupervised learning. The recommendation model learns a correlation between a user preference and a wireless audio device or a function configuration. Key features such as sound quality, a battery life, a price range, and a user rating of the device, as well as relevant features in the user profile are extracted and used as an input of the model. When the user accesses the APP, the model predicts in real time a most suitable wireless audio device or function configuration for the user based on a current user profile and contextual information (such as time, a location, and an activity status). Based on a prediction result of the machine learning model, a personalized recommendation list is generated, and a recommendation result is displayed in a user-friendly manner, for example, through a list, a card, or an interactive interface. In addition, a reason for a recommendation and a device/function highlight are provided. Furthermore, "like", "dislike", "collect", and other feedback options can be set to collect the user's feedback on the recommendation result, which can be used for model optimization.

The APP intelligently recommends the most suitable wireless audio device or the specific function configuration for the user, such that the following benefits can be achieved:

Enhancing the user experience: Through the intelligent recommendation, the user can more easily find his/her most suitable wireless audio device or function configuration, thereby improving use satisfaction and loyalty.

Increasing the user stickiness: The personalized recommendation enhances attractiveness of the APP, encouraging the user to use the APP more frequently and increasing the user stickiness and the activity level.

Optimizing a resource configuration: An intelligent recommendation system helps the APP allocate a resource more effectively, such as notification pushing and advertisement presentation, thereby improving efficiency of resource utilization.

Promoting sales and conversion: A precise recommendation enhances the user's interest in and purchase intention on a recommended product, thereby boosting sales and conversion rates. Enhancing market competitiveness: By offering differentiated and personalized services, the APP stands out in a highly competitive market, thereby enhancing influence and a market share of a brand.

In an embodiment, the APP of the mobile phone can automatically adjust an audio output parameter (such as the volume or the equalizer setting) based on a sound characteristic that is of a surrounding environment and collected by a built-in microphone of the wireless audio device, thereby optimizing the user experience.

Specifically, when the user starts the APP and connects the wireless audio device, the APP automatically requests and enables the built-in microphone of the device. The microphone continuously collects sound of the surrounding environment. The APP extracts characteristics of the sound by using a signal processing algorithm, such as a noise level, a sound type (a human voice, traffic noise, a natural sound, or the like), and a sound frequency distribution. Based on a level of environmental noise, the APP automatically adjusts a volume of an audio output, for example, increases the volume in a noisy environment or reduces the volume in a quiet environment to maintain clarity of audio content. Based on the sound type or the frequency distribution, the APP adjusts the equalizer setting to enhance or reduce an audio output of a specific frequency band, in order to improve sound quality and auditory impression. When the environmental noise varies greatly, the APP can apply a dynamic range compression technology to balance high and low volumes of the audio output, thereby avoiding discomfort caused by a sudden volume change. Additionally, the APP allows the user to adjust basic parameters of the audio output based on his/her own preference, such as a preset volume level and an equalizer curve. Based on the user's usage feedback and habit, the APP uses the machine learning algorithm to gradually optimize an adjustment strategy of the audio output parameter, making the adjustment strategy more in line with the personalized need of the user. Additionally, the APP continuously listens to a change in environmental sound in real time, and adjusts the audio output parameter promptly to adapt to an environmental change. When the APP adjusts the audio output parameter significantly, the user is notified through a screen or voice prompt to ensure that the user is aware of a current audio status.

The audio output parameter is automatically adjusted, such that the following benefits can be achieved:

Improving audio quality experience: By automatically adjusting the audio output parameter, the APP can maintain the clarity and sound quality of the audio content under different environmental conditions, enhancing auditory experience of the user.

Enhancing the user satisfaction: The user does not need to manually adjust an audio setting, and the APP can intelligently adapt to the environmental change, thereby reducing an operational burden on the user and enhancing the user satisfaction.

Enhancing convenience of use: The automatic adjustment function of the APP simplifies an operation process of the audio device, allowing the user to focus more on the audio content itself and enhancing the convenience of use.

Enhancing product competitiveness: By offering the intelligent audio adjustment function, the APP stands out among its peers, thereby enhancing the market competitiveness and user attractiveness of the product.

In an embodiment, after granting the subsequent function permission to the wireless audio device, the APP of the mobile phone, in combination with a Global Positioning System (GPS) or another positioning technology, automatically switches to a preset audio device or configuration file when detecting that the user has entered a specific area (such as a home or an office).

Specifically, the APP integrates the GPS, a Wi-Fi positioning technology, a base station positioning technology, or an indoor positioning technology, and selects an appropriate positioning method based on an environment in which the user is located. The APP fuses a plurality of types of positioning data through an algorithm to enhance positioning precision and accurately determine an area in which the user is located. The user can also set a specific area through the server or the interface of the APP, such as the home or the office, and mark geographical coordinates or a Wi- Fi network ID for each area. The user presets an audio device or a configuration file for each area. For example, in the home, the Bluetooth earphone is used to play soft music, while in the office, the wireless speaker is used to play productivity-boosting work music. The APP can obtain location information of the user in real time and determine whether the user enters the preset specific area. When the user enters the specific area, the APP determines, according to a preset rule, whether to switch the audio device or the configuration file. When a switching condition is met, the APP automatically switches the audio output to the preset device or configuration file, without requiring any manual operation by the user. During the automatic switching, the APP notifies the user through a screen or voice prompt to ensure that the user is aware of a change in a current audio device or configuration. The user can also manually adjust an automatic switching rule through the interface of the APP or temporarily switch the audio device or the configuration file to meet a personalized need.

The automatic switching to the preset audio device or configuration file can achieve the following benefits:

The APP automatically switches the audio device or the configuration file based on the area in which the user is located, thereby reducing manual operations required by the user and enhancing the convenience of use and the user experience.

Enhancing audio adaptability: By presetting audio configurations for different areas, the APP can intelligently adapt to different environments and provide audio experience more in line with a user need.

Improving device utilization: The automatic switching function enables the wireless audio device to be fully utilized in different scenarios, thereby enhancing use efficiency and value of the device.

Increasing the user stickiness: An intelligent audio management function enhances the attractiveness of the APP, making the user be more dependent on and trust the APP, and increasing the user stickiness.

Promoting product differentiation: By offering the unique automatic switching function, the APP stands out among its peers and enhances the market competitiveness and a differentiation advantage of the product.

The above method for identifying a wireless audio device based on audio routing information actively sends the routing notification containing the device type, MAC address, and name information to the APP of the mobile phone through the wireless audio device and combines server-side database matching to accurately identify the wireless audio device. This method overcomes problems of inaccurate and inefficient identification that may occur in a traditional identification technique, ensuring accuracy and timeliness of device identification. Furthermore, through the APP of the mobile phone, the user can conveniently view and manage all wireless audio devices that have been connected or can be connected. This not only simplifies the operation process but also enhances the user experience, allowing the user to more intuitively understand and control a usage status of his/her audio device. Additionally, this technology can monitor a connection status of the wireless audio device in real time, including device connection and disconnection events. This real-time monitoring function ensures that the user can understand the connection status of the device in the timely manner and make a corresponding adjustment or response, thereby improving stability and reliability of device usage. In addition, this technology uses a Bluetooth audio device as an identification object and has wide compatibility. Regardless of a mobile phone platform, seamless compatibility and adaptation can be achieved provided that the device supports a Bluetooth function. This solves a problem of poor compatibility at an iOS end in the prior art and provides convenience for more users.

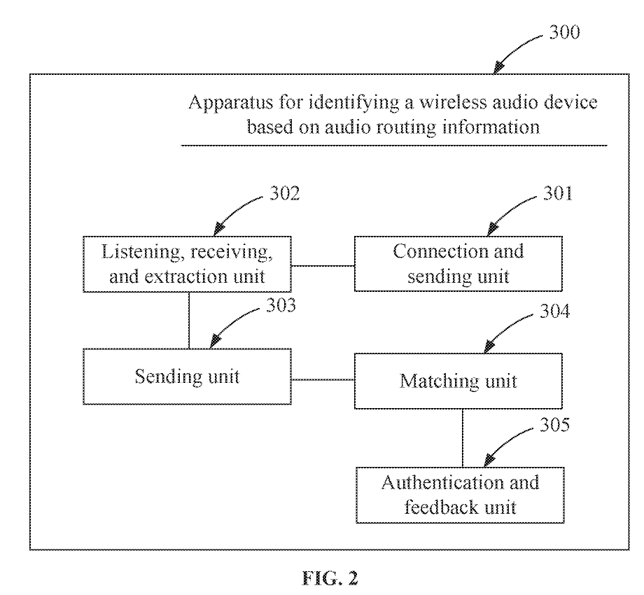

FIG. 2 is a schematic block diagram of an apparatus 300 for identifying a wireless audio device based on audio routing information according to an embodiment of the present disclosure. As shown in FIG. 2, corresponding to the above method for identifying a wireless audio device based on audio routing information, the present disclosure further provides the apparatus 300 for identifying a wireless audio device based on audio routing information. The apparatus 300 for identifying a wireless audio device based on audio routing information includes units configured to execute the above method for identifying a wireless audio device based on audio routing information. The apparatus 300 can be configured in a server. Specifically, referring to FIG. 2, the apparatus 300 for identifying a wireless audio device based on audio routing information includes a connection and sending unit 301, a listening, receiving, and extraction unit 302, a sending unit 303, a matching unit 304, and an authentication and feedback unit 305.

The connection and sending unit 301 is configured to generate, after a wireless audio device connects to a mobile phone, a routing notification containing device type, MAC address, and name information of the wireless audio device, and send the routing notification to an APP of the mobile phone.

The listening, receiving, and extraction unit 302 is configured for the APP of the mobile phone to listen to and receive the routing notification, and extract the device type, MAC address, and name information in the routing notification to obtain routing notification content.

The sending unit 303 is configured to send the routing notification content to a server by the APP of the mobile phone, where the server pre-stores a product information database for a plurality of wireless audio devices.

The matching unit 304 is configured to match the received routing notification content with pre-stored product information in the product information database by the server.

The authentication and feedback unit 305 is configured to: determine, when the routing notification content is consistent with the pre-stored product information in the product information database, that authentication is successful, and feed an authentication result back to the APP of the mobile phone.

In an embodiment, the apparatus 300 further includes: an obtaining and listening unit configured to obtain a permission of an audio manager of the mobile phone, and register a listening function with the audio manager of the mobile phone to listen to a connection status event of the wireless audio device, where when a connection status between the wireless audio device and the mobile phone changes, the APP of the mobile phone receives a status event that has been listened to, and the status event contains device list information.

In an embodiment, in the listening, receiving, and extraction unit 302, the APP of the mobile phone traverses the device list information to select the wireless audio device, obtains the routing notification of the wireless audio device, and extracts the device type, MAC address, and name information in the routing notification to obtain the routing notification content.

In an embodiment, the apparatus 300 further includes: an authorization unit configured for the APP of the mobile phone to grant a subsequent function permission to the wireless audio device, and allow the wireless audio device to perform an audio playback operation or a setting adjustment operation.

It should be noted that those skilled in the art may clearly understand that, for specific implementation processes of the above apparatus 300 for identifying a wireless audio device based on audio routing information and each unit, reference may be made to the corresponding descriptions in the method embodiments, and details are not described herein again for the sake of convenience and simplicity.

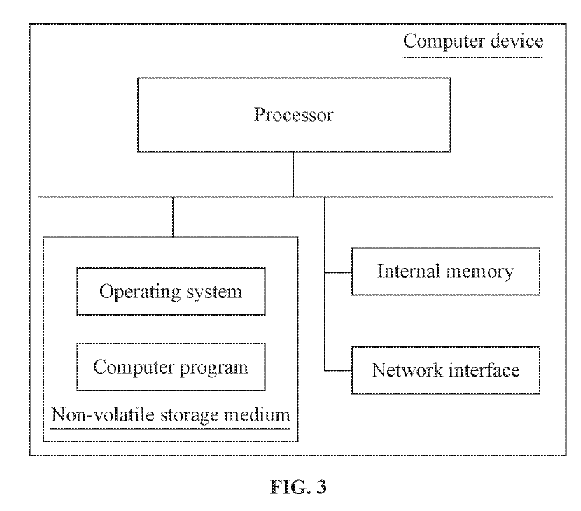

In an embodiment, a computer device is provided. The computer device may be a server, and an internal structure thereof may be as shown in FIG. 3. The computer device includes a processor, a memory, a network interface, and a database that are connected through a system bus. The processor of the computer device is configured to provide computing and control capabilities. The memory of the computer device includes a non-volatile and/or volatile storage medium and an internal memory. The non-volatile storage medium stores an operating system, a computer program, and a database. The internal memory provides an environment for running the operating system and the computer program in the non-volatile storage medium. The network interface of the computer device is configured to connect to and communicate with an external mobile phone through a network. The computer program is executed by the processor to implement server-side functions or steps of a method for identifying a wireless audio device based on audio routing information.

In an embodiment, a computer device is provided, including a memory, a processor, and a computer program stored in the memory and executable on the processor. The processor executes the computer program to implement the following steps:

generating, by a wireless audio device after connecting to a mobile phone, a routing notification containing device type, MAC address, and name information of the wireless audio device, and sending the routing notification to an APP of the mobile phone; listening to and receiving, by the APP of the mobile phone, the routing notification, and extracting the device type, MAC address, and name information in the routing notification to obtain routing notification content; sending, by the APP of the mobile phone, the routing notification content to a server, where the server pre-stores a product information database for a plurality of wireless audio devices; matching, by the server, the received routing notification content with pre-stored product information in the product information database; and determining, when the routing notification content is consistent with the pre-stored product information in the product information database, that authentication is successful, and feeding an authentication result back to the APP of the mobile phone.

In an embodiment, a computer-readable storage medium is provided. The computer- readable storage medium stores a computer program, and the computer program is executed by a processor to implement the following steps:

generating, by a wireless audio device after connecting to a mobile phone, a routing notification containing device type, MAC address, and name information of the wireless audio device, and sending the routing notification to an APP of the mobile phone; listening to and receiving, by the APP of the mobile phone, the routing notification, and extracting the device type, MAC address, and name information in the routing notification to obtain routing notification content; sending, by the APP of the mobile phone, the routing notification content to a server, where the server pre-stores a product information database for a plurality of wireless audio devices; matching, by the server, the received routing notification content with pre-stored product information in the product information database; and determining, when the routing notification content is consistent with the pre-stored product information in the product information database, that authentication is successful, and feeding an authentication result back to the APP of the mobile phone.

It should be noted that, for the functions or steps that can be implemented by the above computer-readable storage medium or computer device, reference may be made to relevant descriptions of a server side and a mobile phone side in the aforementioned method embodiments. To avoid repetition, details are not described herein again.

Those of ordinary skill in the art may understand that all or some of the procedures in the method of the above embodiments may be implemented by a computer program instructing related hardware. The computer program may be stored in a non-volatile computer-readable storage medium. When the computer program is executed, the procedures in the embodiments of the above method may be performed. Any reference to a memory, a storage, a database, or other media used in various embodiments provided in the present disclosure may include a non-volatile memory and/or a volatile memory. The non-volatile memory may include a read-only memory (ROM), a programmable ROM (PROM), an electrically programmable ROM (EPROM), an electrically erasable programmable ROM (EEPROM), or a flash memory. The volatile memory may include a random access memory (RAM) or an external cache memory. As an illustration rather than a limitation, the RAM can be obtained in a plurality of forms, such as a static RAM (SRAM), a dynamic RAM (DRAM), a synchronous DRAM (SDRAM), a double data rate SDRAM (DDRSDRAM), an enhanced SDRAM (ESDRAM), a synchronization link (Synchlink) DRAM (SLDRAM), a Rambus direct RAM (RDRAM), a direct Rambus dynamic RAM (DRDRAM), and a Rambus dynamic RAM (RDRAM).

Those skilled in the art should clearly understand that, for convenient and concise description, only the division of the above-mentioned functional units/modules is used as an example for illustration. In practical application, the above-mentioned functions may be realized by different functional units/modules as required, that is, the internal structure of the apparatus is divided into different functional units or modules to complete all or part of the above-described functions.

The foregoing embodiments are only used to explain the technical solutions of the present disclosure, and are not intended to limit the present disclosure. Although the present disclosure is described in detail with reference to the above embodiments, persons of ordinary skill in the art should understand that they can still modify the technical solutions described in the above embodiments, or make equivalent substitutions on some technical features therein. These modifications or substitutions do not make the essence of the corresponding technical solutions deviate from the spirit and scope of the technical solutions in the embodiments of the present disclosure, and shall fall within the protection scope of the present disclosure.

1. A method for identifying a wireless audio device based on audio routing information, comprising:
generating, by a wireless audio device after connecting to a mobile phone, a routing notification containing device type, Media Access Control (MAC) address, and name information of the wireless audio device, and sending the routing notification to an application (APP) of the mobile phone;
listening to and receiving, by the APP of the mobile phone, the routing notification, and extracting the device type, MAC address, and name information in the routing notification to obtain routing notification content;
sending, by the APP of the mobile phone, the routing notification content to a server, wherein the server pre-stores a product information database for a plurality of wireless audio devices;
matching, by the server, the received routing notification content with pre-stored product information in the product information database; and
determining, when the routing notification content is consistent with the pre-stored product information in the product information database, that authentication is successful, and feeding an authentication result back to the APP of the mobile phone.

2. The method for identifying a wireless audio device based on audio routing information according to claim 1, wherein before the generating, by a wireless audio device after connecting to a mobile phone, a routing notification containing device type, MAC address, and name information of the wireless audio device, and sending the routing notification to an APP of the mobile phone, the method further comprises:
obtaining, by the APP of the mobile phone, a permission of an audio manager of the mobile phone, and registering a listening function with the audio manager of the mobile phone to listen to a connection status event of the wireless audio device, wherein when a connection status between the wireless audio device and the mobile phone changes, the APP of the mobile phone receives a status event that has been listened to, and the status event contains device list information.

3. The method for identifying a wireless audio device based on audio routing information according to claim 2, wherein the listening to and receiving, by the APP of the mobile phone, the routing notification, and extracting the device type, MAC address, and name information in the routing notification to obtain routing notification content comprises:
traversing, by the APP of the mobile phone, the device list information to select the wireless
audio device, obtaining the routing notification of the wireless audio device, and extracting the device type, MAC address, and name information in the routing notification to obtain the routing notification content.

4. The method for identifying a wireless audio device based on audio routing information according to claim 1, wherein after the determining, when the routing notification content is consistent with the pre-stored product information in the product information database, that authentication is successful, and feeding an authentication result back to the APP of the mobile phone, the method further comprises:
granting, by the APP of the mobile phone, a subsequent function permission to the wireless audio device, and allowing the wireless audio device to perform an audio playback operation or a setting adjustment operation.

5. An apparatus for identifying a wireless audio device based on audio routing information, comprising:
a connection and sending unit configured to generate, after a wireless audio device connects to a mobile phone, a routing notification containing device type, MAC address, and name information of the wireless audio device, and send the routing notification to an APP of the mobile phone;
a listening, receiving, and extraction unit configured for the APP of the mobile phone to listen to and receive the routing notification, and extract the device type, MAC address, and name information in the routing notification to obtain routing notification content;
a sending unit configured to send the routing notification content to a server by the APP of the mobile phone, wherein the server pre-stores a product information database for a plurality of wireless audio devices;
a matching unit configured to match the received routing notification content with pre-stored product information in the product information database by the server; and
an authentication and feedback unit configured to: determine, when the routing notification content is consistent with the pre-stored product information in the product information database, that authentication is successful, and feed an authentication result back to the APP of the mobile phone.

6. The apparatus for identifying a wireless audio device based on audio routing information according to claim 5, further comprising:
an obtaining and listening unit configured to obtain a permission of an audio manager of the
mobile phone, and register a listening function with the audio manager of the mobile phone to listen to a connection status event of the wireless audio device, wherein when a connection status between the wireless audio device and the mobile phone changes, the APP of the mobile phone receives a status event that has been listened to, and the status event contains device list information.

7. The apparatus for identifying a wireless audio device based on audio routing information according to claim 6, wherein in the listening, receiving, and extraction unit, the APP of the mobile phone traverses the device list information to select the wireless audio device, obtains the routing notification of the wireless audio device, and extracts the device type, MAC address, and name information in the routing notification to obtain the routing notification content.

8. The apparatus for identifying a wireless audio device based on audio routing information according to claim 5, further comprising:
an authorization unit configured for the APP of the mobile phone to grant a subsequent function permission to the wireless audio device, and allow the wireless audio device to perform an audio playback operation or a setting adjustment operation.

9. A computer device, comprising a memory, a processor, and a computer program stored in the memory and executable on the processor, wherein the processor executes the computer program to implement the steps of the method for identifying a wireless audio device based on audio routing information according to claim 1.

10. A non-volatile storage medium, wherein the computer-readable storage medium stores a computer program, and the computer program is executed by a processor to implement the steps of the method for identifying a wireless audio device based on audio routing information according to claim 1.
